(19) United States
(12) Patent Application Publication
(10) Pub. No.: US 2005/0060998 A1
(43) Pub. Date: Mar. 24, 2005

(54) Rotary motion machine

(76) Inventor: Manfred R. Kuehnle, Lincoln, MA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 10/761,120

(22) Filed: Jan. 20, 2004

Related U.S. Application Data
(60) Provisional application No. 60/442,348, filed on Jan. 23, 2003.

(51) Int. Cl. F02B 71/04

(52) U.S. Cl. 60/595

(57) ABSTRACT

A rotary motion machine and method of operation that includes at least one radially expandable piston defining an inner chamber having a volume that varies upon radial expansion and contraction of the piston, a core defining, at least in part, a cylinder in which the piston is positioned, a rotor rotationally movable relative to the core and being rotated by a relatively incompressible fluid driven by expansion of the piston, and at least one magnet associated with the rotor that, upon rotation of the rotor, generates electricity in a cooperatively arranged coil. A novel fuel injector atomizes and injects fuel along the length of the inner chamber. The piston can include a spiral of thin, flexible foil of amorphous material having a strip of a crystalline material for causing the spiral to expand after contraction. In one embodiment, the spiral has a melting temperature of about 3,200 degrees Celsius.

### RELATED APPLICATION

This application claims the benefit of U.S. Provisional Application No. 60/442,348, filed Jan. 23, 2003, the entire teachings of which are incorporated herein by reference.

### BACKGROUND

A rotary motion machine has been proposed by the present inventor as described in U.S. Pat. No. 5,832,731, the entire teachings of which are incorporated herein by reference. Some of the benefits, including advantages of such an engine over traditional engines, are disclosed therein.

### SUMMARY

It has been discovered that the engine can be more effective and that inventive improvements are needed. For example, the improvements include an improved method and apparatus to inject fuel into the combustion chamber, an alternative method and apparatus that uses the output energy of the machine, improvements relating to the radially expandable piston, improved ways to increase the thermal efficiency and torque of the machine, improved configuration of the intake and outlet valves of the engine, an improved method and apparatus to minimize noise associated with fuel combustion in the engine, and an improved method and apparatus relating to the sequence of the operational events of the machine.

A rotary motion machine is provided in accordance with aspects of the present invention in which the machine includes at least one radially expandable piston defining an inner chamber having a volume that varies upon radial expansion and contraction of the piston, a core defining, at least in part, a cylinder in which the piston is positioned, a rotor rotationally movable relative to the core and being rotated by a relatively incompressible fluid driven by expansion of the piston, and at least one magnet associated with the rotor that, upon rotation of the rotor, generates electricity in a cooperatively arranged coil. The magnet can include a permanent magnet or an electromagnet. In specific embodiments, the electricity has a frequency of 50 hertz or 60 hertz.

A fluid injector is provided in accordance with other aspects of the present invention comprising two concentric tubes movable with respect to one another with each tube having a plurality of apertures that cooperate to atomize at least a portion of fluid disposed within the tubes. Movement of one of the tubes prevents the fluid from being atomized in a closed position. In a particular embodiment, the plurality of apertures of each tube are micron size and are disposed along substantially the full length of the tubes. The relative movement of the tubes corresponds to the amount of fluid that is atomized. The fluid injector can be used to distribute fuel along the length of a combustion chamber in a rotary motion machine.

A radially expandable piston for use in a rotary motion machine is provided comprising a spiral of thin, flexible material coiled up about a central axis. The spiral includes a first end and a second end positionable adjacent a first core plate and a second core plate, respectively, of the rotary motion machine. The first end and the second end of the spiral can include in-folded portions that create a seal against the first core plate and the second core plate. In specific embodiments, the spiral is configured to allow a fluid in between spiral layers. In one embodiment, projections can be used to form portals for allowing fluid in between spiral layers.

The spiral can include a sealing member attached at an inner end thereof for creating a seal against itself. For example, the sealing member can contain the combustion force within a chamber defined in part by the spiral. The spiral can include a folded portion at an inner end of the piston to prevent fluid from reaching the inner chamber defined by the spiral. The spiral can include a foil of amorphous material having a strip of a crystalline material for causing the spiral to expand after contraction. In one embodiment, the spiral is formed from an amorphous, non-crystalline material having a melting temperature of about 3,200 degrees Celsius. At least one strip of material can be attached to the spiral for causing the spiral to expand after being contracted.

A rotary motion machine is provided comprising at least one radially expandable piston defining an inner chamber having a volume that varies upon radial expansion and contraction of the piston, a core defining, at least in part, a cylinder in which the piston is positionable, and a rotor rotationally movable relative to the core and being rotated by a relatively incompressible fluid driven by expansion of the piston. The core can have a plurality of apertures through which fluid flows to cool the machine.

A rotary motion machine is provided in accordance with further aspects of the present invention, comprising at least one radially expandable piston defining an inner chamber having a volume that varies upon radial expansion and contraction of the piston, a first core plate and a second core plate bounding the piston on first and second ends thereof, and at least one intake valve and at least one outlet valve mountable on the first core plate or the second core plate for communicating with the inner chamber of the piston. The intake valve and the outlet valve can be positioned substantially flush with that surface of the first core plate or the second core plate that bounds the piston. An anechoic chamber can be formed at the outlet valve for reducing machine noise. In one embodiment, the intake valve allows pre-compressed fluid into the chamber, and the outlet valve allows exhaust produced from fuel combustion within the chamber to leave the chamber.

In other embodiments, a rotary motion machine is provided comprising at least one radially expandable piston defining an inner chamber having a volume that varies upon radial expansion and contraction of the piston, a first core plate and a second core plate bounding the piston on each end, and at least one intake valve and at least one outlet valve mountable on the first core plate or the second core plate. The second core plate defines at least part of an anechoic chamber adjacent at least the outlet valve for minimizing noise associated with fuel combustion within the piston.

A method for operating a rotary motion machine is provided which includes atomizing and injecting a liquid fuel into and along a length of a chamber defined by a radially expandable piston wherein the fuel combusts creating exhaust and causing the piston to radially expand. The method further includes replacing substantially all of the exhaust with pre-compressed fluid as the piston is caused to contract and repeating these steps.

In a specific embodiment, substantially all of the exhaust is replaced with pre-compressed fluid at least while the piston is caused to contract. The piston is caused to contract in one embodiment by a relatively incompressible fluid propelled by a second radially expandable piston expanding due to fuel combustion therein.

At least one fuel injector that selectively injects liquid fuel into the chamber, a fluid intake valve that allows pre-compressed fluid into the chamber, and at least one outlet valve that selectively allows the exhaust to exit the chamber are closed during the fuel combustion. The fluid intake valve and the outlet valve are opened about when the piston has expanded to about its maximum dimension to allow the exhaust to leave the chamber as the piston is caused to contract. The outlet valve is closed about when substantially all of the exhaust has been replaced by the compressed fluid. In a particular embodiment, substantially all of the exhaust has been replaced by the pre-compressed fluid about when the piston has contracted to about one-half its maximum diameter.

The method can also include closing the fluid intake valve and the outlet valve about when the piston is contracted to about one-half its maximum diameter, wherein the continued contraction of the piston further compresses the pre-compressed fluid. The fluid injector injects fuel into the chamber about when the piston is contracted to its minimum diameter to atomize and inject a liquid fuel into and along a length of the chamber.

In other embodiments, a rotary motion machine is provided which includes at least one radially expandable piston defining an inner chamber having a volume that varies upon radial expansion and contraction of the piston, the piston being formed from a heat-reflective material to contain heat produced by fuel combustion within the chamber, a core defining, at least in part, a cylinder in which the piston is positionable, and a rotor rotationally movable relative to the core and being rotated by a relatively incompressible fluid driven by expansion of the piston. The heat produced in the chamber is contained therein, i.e., resulting in less heat loss, thereby increasing the operating temperature of the machine, which increases thermal efficiency.

In a specific embodiment of the invention, a rotary motion machine is provided which includes at least one radially expandable piston defining an inner chamber having a volume that varies upon radial expansion and contraction of the piston, a core defining, at least in part, a cylinder in which the piston is positionable, the core including a plurality of apertures for cooling the core for increasing the thermal efficiency of the machine thereby increasing torque, and a rotor rotationally movable relative to the core and being rotated by a relatively incompressible fluid driven by expansion of the piston. This cooling action increases the thermal efficiency by increasing the thermal differential of the machine, thereby increasing torque. A fluid can be circulated through the plurality of apertures for cooling the core.

A rotary motion pump is provided which includes a rotor driven about a central axis, wherein the rotor has bearing surfaces that force a relatively incompressible fluid to cause at least one radially expandable piston to expand and contract about a longitudinal axis thereof, the motion of the expansion and contraction of the piston pumping a fluid along the longitudinal axis of the piston. In a specific embodiment, the pump includes a one-way valve on each end of the piston to control the direction that the fluid is pumped. The rotor can be driven by a belt connectable to a motor. The pump can be used in a medical device, such as an artificial heart to pump blood.

### BRIEF DESCRIPTION OF THE DRAWINGS

The foregoing and other objects, features and advantages of the invention will be apparent from the following more particular description of various embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a perspective view of a rotary motion machine in accordance with an embodiment of the present invention.

FIG. 2 is a cross-sectional view of the machine illustrated in FIG. 1.

FIG. 3 is a partial cross-sectional view of a piston within a cylinder in the machine illustrated in FIG. 1.

FIG. 4 is a top view of a piston in a power-stroke stage in accordance with an embodiment of the invention.

FIG. 5 is a top view of a piston in a contracting stage in accordance with an embodiment of the invention.

FIG. 6 is a top view of a piston in a power-stroke stage in accordance with another embodiment of the present invention.

FIG. 7 is a partial side view of a conventional gas-powered engine.

FIG. 8 is a partial perspective view of an outer side of a spiral piston that is positionable within a cylinder in the machine illustrated in FIG. 1.

FIG. 9 is a partial perspective view of an inner side of a spiral piston that is positionable within a cylinder in the machine illustrated in FIG. 1.

FIG. 10 is a partial cross-sectional view of the spiral piston of FIG. 1.

FIG. 11 is a cross-sectional view of the spiral piston of FIG. 1.

### DETAILED DESCRIPTION

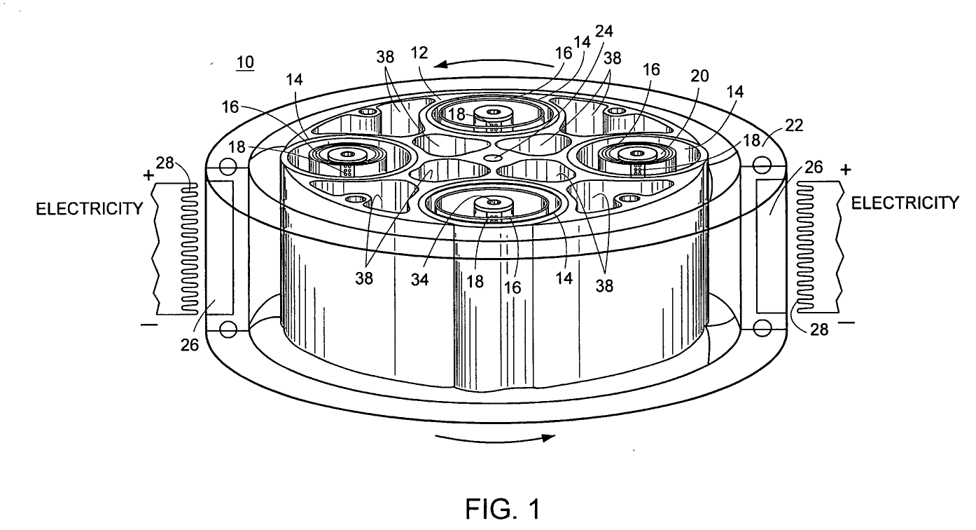

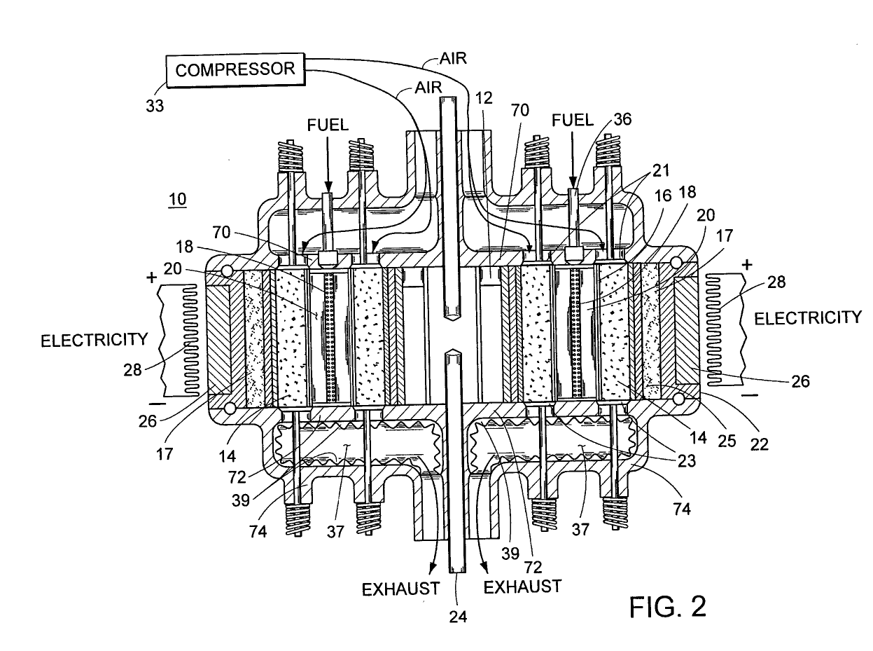

A description of various embodiments of the invention follows. FIGS. 1 and 2 illustrate a rotary motion machine, designated generally by reference numeral 10, that has been constructed according to principles of the present invention. Generally, a core 12 defines at least part of cylinders 14 in which radially expandable pistons 16 are positioned. A fluid or fuel injector 18 positioned within each piston 16 atomizes and injects a fuel into an inner chamber 20 defined by each piston. The fuel combusts and causes the piston 16 to radially expand, which forces a relatively incompressible fluid 17, such as oil or hydraulic fluid, which is positioned on the outer side of the piston 16, to propel a rotor or flywheel 22 to rotate about an axis 24. Additional details regarding the operation of the machine 10 are given below.

One or more magnets or electromagnets 26 carried by the rotor 22 are thus rotated in a path about axis 24 past one or more cooperatively arranged coils 28 to generate electricity therein in accordance with magnetic induction principles. In a particular embodiment, the rotor 22 turns at about 300 revolutions per minute (rpm) when using a 50 millisecond cycle time for each cylinder 14 or five revolutions per second (rps) in a four cylinder machine. That is, five rps multiplied by 60 seconds yields 300 rpm. With ten magnets, for example, on the rotor 22, 50 hertz frequency electricity is produced, and with twelve magnets, 60 hertz frequency electricity is produced. The generated electricity can be used to power electric motors, for example, in automotive platforms that are equipped with electrical wheel drives, for example, automobiles, trucks, forklifts, agricultural vehicles, earth-moving machines, off-road vehicles, snowmobiles, military vehicles, and helicopters with direct drive of the main shaft.

As best seen in FIGS. 2-5, the fuel injector 18 in this embodiment includes two concentric members or tubes movable with respect to one another. An inner tube 30 having a plurality of apertures along its length is concentrically positioned within an outer tube 32 along a longitudinal axis 34 of the inner chamber 20. The outer tube 32 also has a plurality of apertures along its length that cooperate with the apertures of the inner tube 30 to meter, atomize, and inject a precise amount of liquid fuel into and along the length of the inner chamber 20. In a particular embodiment, shaft 36 can be used to turn either tube 30 or 32 relative to the other tube.

The inner tube 30 contains, in a particular embodiment, liquid fuel within an inner cavity thereof. The outer tube 32 has apertures precisely located relative to the apertures of the inner tube 30 such that, in a closed position, the fuel is contained within the tube 30. That is, when the apertures of the inner tube 30 do not align with the apertures in the outer tube 32, the fuel injector 18 is said to be in a closed position. As one of the tubes is rotated, respective apertures of the tubes 30, 32 begin to align allowing a small amount of liquid fuel to be atomized and injected into the chamber 20. In the open position, the apertures of the respective tubes are geometrically congruent, i.e., aligned. The relative movement of the tubes 30, 32 thus corresponds to the amount of fluid that is atomized. Because the fuel is distributed along the length of the chamber 20, the combustion force propelling piston 16 is substantially the same along the length thereof. The fuel efficiency is improved over traditional combustion engines wherein fuel is injected at specific locations, for example, the top of the combustion chamber.

Because the combustion temperature of the machine 10 can be up to about 1800 degrees Celsius, the tubes 30, 32 are formed from a high temperature material, such as tungsten or a tungsten alloy, e.g., tungsten coated with iridium. Since the fuel is positioned within the tubes 30, 32 before injection, the fuel is pre-heated from heat generated within chamber 20 before being injected into the chamber 20, thereby improving fuel efficiency. In specific embodiments, the aperture geometry of the apertures of tubes 30, 32 is small enough to atomize the fluid passing therethrough. In one embodiment, the apertures of tubes 30, 32 are circular, having a diameter between about 0.5 and 5 micrometers. In a particular embodiment, the fuel within the tube 30 is pressurized to aid in the injection of the fluid into the chamber 20.

The fluid or fuel injector 18 can also be employed in other applications where a fluid is desired to be distributed along the length of the injector. In particular embodiments, the fluid includes a combustible fuel such as gasoline or diesel fuel, melt, resins, plastics, or other suitable fluids.

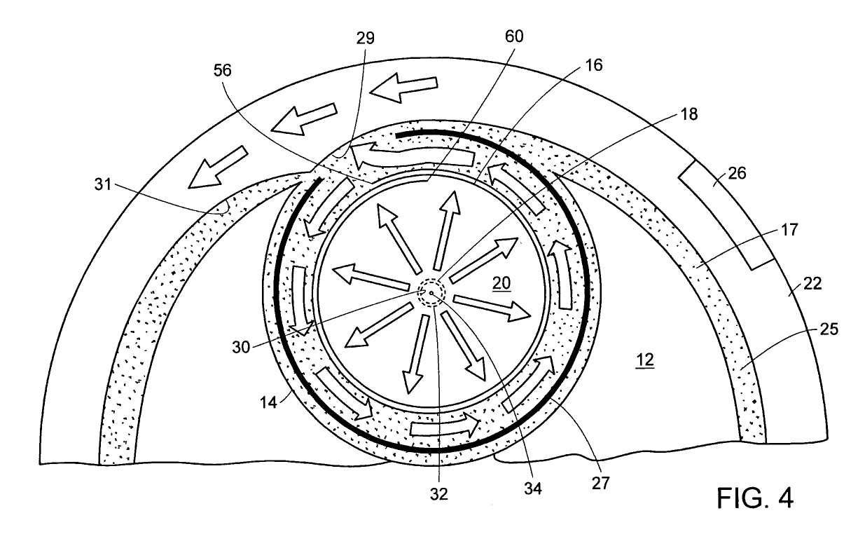

As particularly shown in FIG. 1, the core 12 has a plurality of apertures or openings 38 through which fluid flows to cool the machine 10. In a particular embodiment, cooling fluid within apertures 38 does not exceed about 400 degrees Celsius. This cooling action increases the thermal efficiency by increasing the thermal differential of the machine 10, thereby increasing torque. The core 12 absorbs heat from each piston 16 through ring 27 (FIGS. 4-6). In specific embodiments of the invention, the ring 27 can be formed from a high temperature steel or other suitable materials.

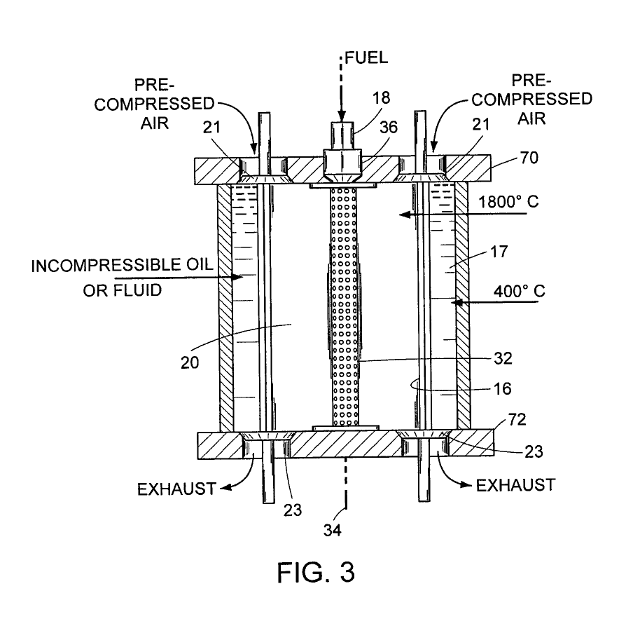

FIGS. 2 and 3 illustrate piston(s) 16 positioned within a first or top core plate 70 and a second or bottom core plate 72. Fluid inlet or intake valves 21 mounted on the top core plate 70, for example, inject a fluid such as air into the inner chamber 20 at a precise time. Outlet valves 23 mounted on the bottom core plate 72, for example, are opened to allow exhaust to exit the chamber 20. In specific embodiments, there can be any number of intake or outlet valves 21, 23, for example, there can be four or six valves 21, 23.

In the embodiment shown, valves 21, 23 are flush with the surface of the top and bottom core plates 70, 72, which makes the valves less visible to the piston 16 to minimize the possibility of the piston hitting a valve. In other embodiments, the valves 21, 23 can have shapes designed to maximize the amount of fluid/exhaust that can enter/exit each chamber 20 during each cycle of the piston 16. That is, the valves 21, 23 are shaped to maximize the area above/below the chamber 20. For example, looking at the top of a particular cylinder 14, the valves 21 can be trapezoidal, triangular, or pie-shaped (with the narrower ends pointing toward the center of the circular-shaped chamber 20) to use the maximize amount of area through which air can be delivered into the chamber 20 per piston 16 cycle. The outlet valves 23 can be similarly shaped to maximize the amount of exhaust that can extracted from the chamber 20 per piston 16 cycle. Beneficially, the machine 10 can be run at higher speeds since an increased volume of pre-compressed air and exhaust pass through the chamber 20, if desired.

In an embodiment of the invention, the top and bottom core plates 70, 72 can be formed from a material that has low surface energy, i.e., a material that has low surface tension. For example, Al₂O₃N₂ (ALON) can be used to form the plates 70,72. Since the plates 70, 72 have low surface energy, fluid, for example, the relatively incompressible fluid 17, tends to form a bead or bubble and not spread along the surface of the plates 70,72, which has the beneficial result of decreasing the likelihood that fluid 17 will leak into the chamber 20.

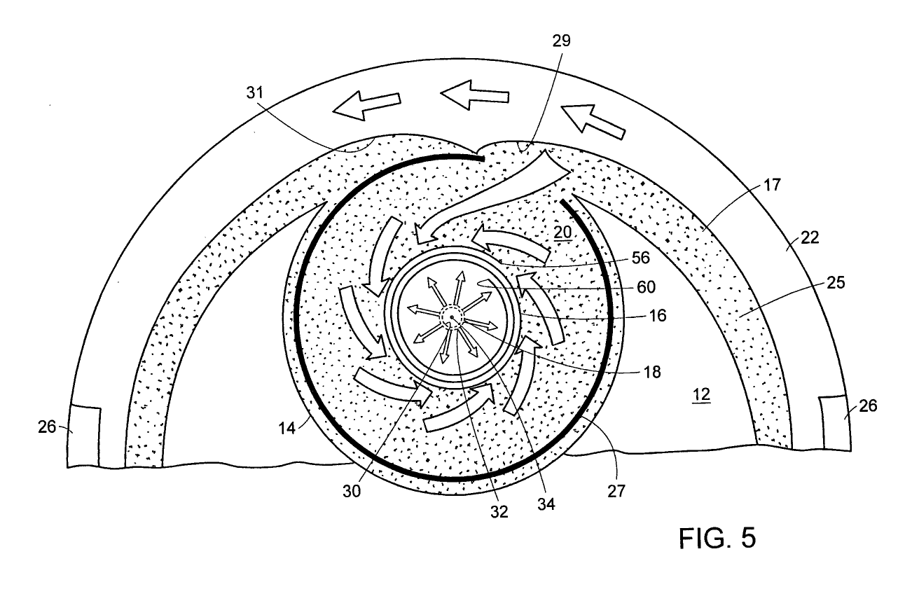

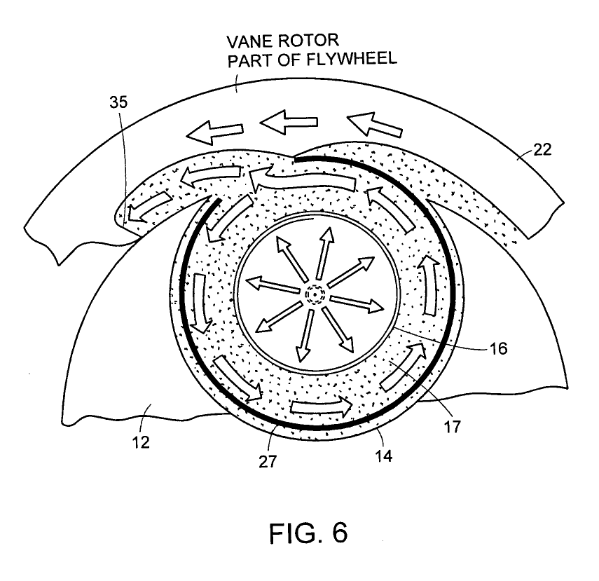

The hydraulic fluid 17 is disposed within a space 25 defined by the outside of the pistons 16, the inside of rotating rings 27, the outside of core 12, and the inside of rotor 22 (FIGS. 4-6). The space 25 is substantially constant, such that hydraulic fluid 17 forced out of one cylinder 14 by an expanding piston 16 pushes on bearing surface 29 of rotor 22 to cause rotation thereof. For example, FIG. 4 illustrates the beginning of a power stroke in which combusting fuel radially expands piston 16 to cause rotation of the rotor 22. Fluid 17 adjacent to a pushing surface 31 of the rotor 22 forces fluid 17 to contract another piston 16, for example, as shown in FIG. 5. Ring 27 rotates to allow fluid 17 into the cylinder 14 (FIG. 5) or to facilitate the ejection of the fluid against bearing surface 29 (FIG. 4). Thus, opposing pistons 16, for example, four or six (four shown in FIG. 1), work in tandem with one piston 16 propelling the fluid 17, which causes a corresponding piston 16 to contract. FIG. 6 illustrates another embodiment of a rotor 22 having a defined cavity 35 which is pushed by the fluid 17.

When the piston 16 has contracted to its minimum diameter (FIG. 5), the intake valve(s) 21 and outlet valve(s) 23 of a particular cylinder 14 are closed as the fuel is injected and combustion takes place. When the piston 16 has expanded to about its maximum diameter (FIG. 4), the intake valve(s) 21 and outlet valves (23) are opened, which allows fluid, such as air, to force the exhaust produced by the combusted fuel out through the outlet valve(s) 23. In a particular embodiment, a compressor 33 (FIG. 2) pre-compresses the air to decrease the time needed to expel the exhaust.

In one embodiment, substantially all of the exhaust is expelled when the piston 16 has contracted to about one-half its maximum diameter. At this point, the intake and outlet valves 21, 23 are closed and the piston 16 is further compressed by the fluid 17, which further compresses the pre-compressed air within chamber 20. When the piston 16 has contracted to about its minimum diameter, the fuel injector 18 injects fuel into the chamber 20, which combusts due to the high operating temperature within chamber 20, similar to a diesel engine. The operation is repeated, thereby turning rotor 22 to generate electricity in coils 28.

In other embodiments, one or more cores and associated pistons can be stacked on top of core 12 to create a “stacked” machine. In particular embodiments, a common fuel injector mechanism can be used to provide fuel within the chamber 20.

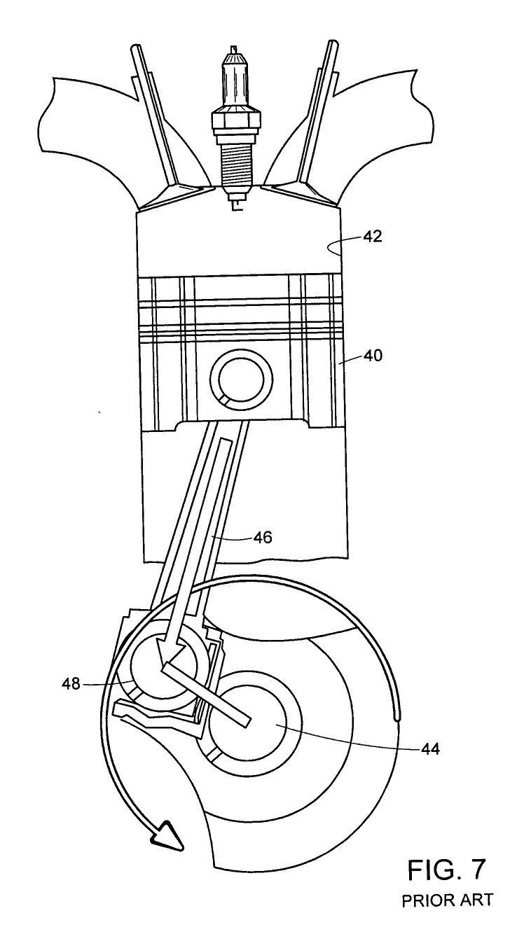

The machine 10 of the present invention has increased torque characteristics over those of a traditional combustion engine. As illustrated in FIG. 7, part of a traditional engine is depicted in which a piston 40 reciprocates within cylinder 42 to turn a crankshaft 44 by moving a connecting rod 46 coupled thereto by a rod bearing 48. It is seen that when the fuel is combusted within cylinder 42, thereby imparting the maximum force to the piston 40, the moment arm to turn the crankshaft 44 is at or near a minimum because it is under the cylinder. That is, torque imparted to the crankshaft 44 is that force applied to the crankshaft multiplied by the distance from the center in a perpendicular direction thereto. Thus, the torque in this engine is not using the full force applied by the piston 40 and thus is inefficient.

In contrast, the torque characteristics of the present machine 10 are improved. During the time that maximum force is applied by piston 16 at the time of combustion, all of the force is being hydrostatically transmitted to the hydraulic fluid 17 to propel the same against and thereby causing rotation of the rotor 22.

To reduce machine noise including noise associated with fuel combustion, one or more anechoic chambers 37 can be provided in further embodiments of the invention. As shown in FIG. 2, the anechoic chamber 37 is formed in part by the bottom plate 72 and housing 74. Surfaces 39 can be structured to absorb and dissipate sound waves.

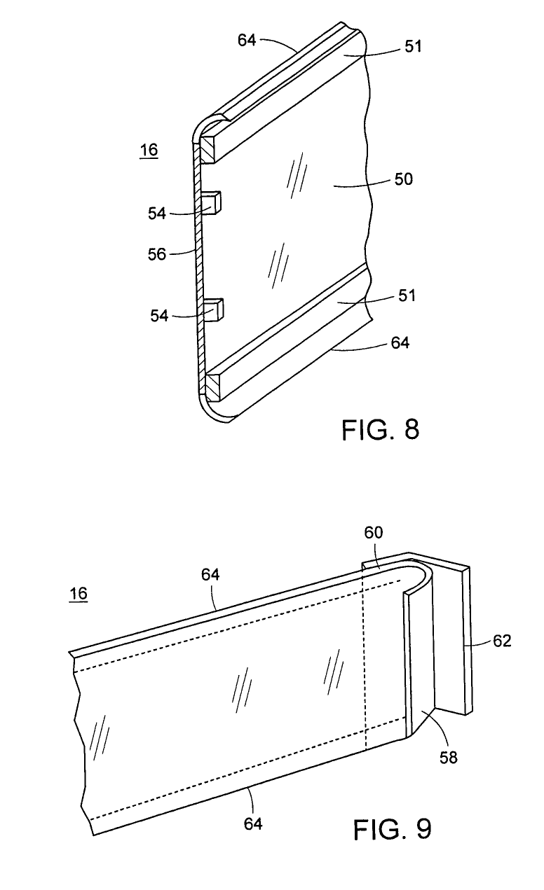

In further embodiments, the piston 16 includes a spiral of thin, flexible material coilable about a central axis. FIG. 8 is a perspective view of an outer end 56 of a piston 16 in a relaxed state. In this embodiment, a strip or foil 50 of material is formed from a high temperature material such as rhenium, which can include an iridium coating. At least one strip 51 of a material that can include a crystalline, hard-to-compress compound, such as tungsten or tungsten/rhenium compounds/alloys, is attached to the strip 50 to provide the “restoring force” to the main strip 50, i.e., to cause the piston 16 to expand after being contracted by the hydraulic fluid 17 even under high temperatures. The strip(s) 51 can have a thickness of between about 100-250 micrometers in a specific embodiment, and be covered with a film of iridium to maximize oxygen inertness at high temperatures. Thus, the piston 16 is manufactured in such a manner as to always maintain its springiness despite the amorphous nature of the main strip 50.

In one embodiment, the piston 16 has a thickness of about 25 micrometers, is formed from an amorphous, non-crystalline structure, and is formed from a heat-reflective material. Because the spiral is heat-reflective, the heat within chamber 20 is contained therein, i.e., resulting in less heat loss, thereby increasing the operating temperature of the machine 10 which increases thermal efficiency. In a particular embodiment, TRI-X material (manufactured by XMX Corporation of Waltham, Mass.) is used to form the piston 16. TRI-X material has a melting temperature over 3,200 degrees Celsius.

In specific embodiments, it is desirable to use fluid, such as the hydraulic fluid 17 that compresses the piston 16, to lubricate the piston 16 as it coils up. In one embodiment, one or more projections 54 are provided at an outer end 56 to create portals at the outermost coil when the piston is coiled up such that hydraulic fluid can be provided in between the coils.

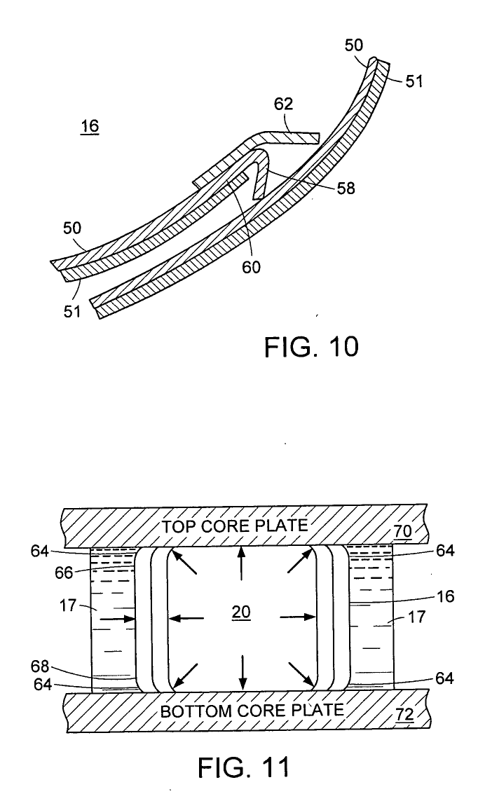

The piston 16 in this embodiment includes a folded portion 58 at an inner end 60 for creating a seal against itself to prevent fluid from reaching the inner chamber 20 (FIGS. 4, 9, and 10). A sealing member 62 can be attached to the inner end 60 for creating a seal against the force generated by the combusting fuel. In one embodiment, sealing member 62 is a tungsten alloy welded to the inner end 60.

As illustrated in FIG. 11, the piston 16 can include in-folded portions 64 at a first end 66 and a second end 68 of the piston to create a seal against a top core plate 70 and a bottom core plate 72, which define at least part of the inner chamber 20. The cylinder is essentially an isostatic chamber. The force in the hydraulic fluid 17 is approximately equal to the gas reaction force plus the acceleration force. Thus, there is no substantial change in force at the boundary of the piston which requires piston rings as in conventional gas-powered engines.

In further embodiments, principles of the present invention can be extended to other applications. For example, the machine 10 can be used as a pump to propel a fluid by motion of the spiral pistons 16. The structures needed to combust fuel in the inner chamber 20 are not needed in some applications. The valves 21, 23, or one-way valves can be positioned on each end of the spiral piston 16, i.e., adjacent the top and bottom core plates 70, 72. The rotor 22 is rotated, for example, by electricity supplied through coils 28 or by a belt coupled to a motor to propel fluid through the chamber 20. In a particular application, the machine 10 can be used as a medical device, such as an artificial heart to pump blood.

While this invention has' been particularly shown and described with references to embodiments thereof, it will be understood by those skilled in the art that various' changes in form and details may be made therein without departing from the scope of the invention encompassed by the appended claims.

1. A rotary motion machine, comprising:
a) at least one radially expandable piston defining an inner chamber having a volume that varies upon radial expansion and contraction of the piston;
b) a core defining, at least in part, a cylinder in which the piston is positioned;
c) a rotor rotationally movable relative to the core and being rotated by a relatively incompressible fluid driven by expansion of the piston; and
d) at least one magnet associated with the rotor that, upon rotation of the rotor, generates electricity in a cooperatively arranged coil.

2. The rotary motion machine of claim 1, wherein the magnet is a permanent magnet or an electromagnet.

3. The rotary motion machine of claim 1, wherein the electricity has a frequency of 50 or 60 hertz.

4. An electricity generator, comprising:
at least one magnet rotated by a rotary motion machine; and
a coil positionable adjacent to a path of the at least one magnet wherein electricity is generated in the coil.

5. The electricity generator of claim 4, wherein the rotary motion machine includes:
a) at least one radially expandable piston defining an inner chamber having a volume that varies upon radial expansion and contraction of the piston;
b) a core defining, at least in part, a cylinder in which the piston is positioned; and
c) a rotor supporting the at least one magnet, the rotor being rotationally movable relative to the core and being rotated by a relatively incompressible fluid driven by expansion of the piston.

6. A fluid injector comprising two concentric tubes movable with respect to one another, each tube having a plurality of apertures that cooperate to atomize at least a portion of fluid disposed within the tubes, movement of one of the tubes preventing the fluid from being atomized.

7. The fluid injector of claim 6, wherein the plurality of apertures are disposed along substantially the full length of the tubes.

8. The fluid injector of claim 6, wherein the relative movement of the tubes corresponds to the amount of fluid that is atomized.

9. The fluid injector of claim 6, wherein the tubes are formed from a high temperature material.

10. The fluid injector of claim 6, wherein the fluid is preheated within the tubes.

11. The fluid injector of claim 6, wherein the fluid includes at least one of a combustible fuel, plastic, melt, resins, and plastic melt.

12. The fluid injector of claim 6, wherein the apertures are substantially circular having a diameter between about 0.5 and 5 micrometers.

13. A fluid injector comprising two concentric tubes, each tube having a plurality of apertures disposed along a common longitudinal axis of the tubes, the plurality of apertures being configured to atomize a fluid.

14. The fluid injector of claim 13, wherein relative motion between the tubes contains the fluid in the tubes in a first position and allows at least a portion of the fluid to be atomized in a second position.

15. A rotary motion machine, comprising:
a) at least one radially expandable piston defining an inner chamber having a volume that varies upon radial expansion and contraction of the piston;
b) a core defining, at least in part, a cylinder in which the piston is positioned;
c) a rotor rotationally movable relative to the core; and
d) a fuel injector disposed within the piston, the fuel injector including a first member disposed along a longitudinal axis of the inner chamber of the piston, the first member including an inner cavity and having a first plurality of apertures extending from the inner cavity to an outside surface of the first member, the fuel injector also comprising a second member surrounding the first member, the second member including a second plurality of apertures that extend from an inside surface to an outside surface of the second member, the first and second plurality of apertures cooperating in such a way as to, in a first position, contain fluid disposed within the inner cavity of the first member and, in a second position, allow at least a portion of fluid disposed within the inner cavity of the first member to pass through the first and second plurality of apertures and into the inner chamber of the piston.

16. The rotary motion machine of claim 15, wherein the aperture geometry of the first and second plurality of apertures is small enough to atomize fluid passing therethrough.

17. The rotary motion machine of claim 15, wherein the rotary motion machine has a combustion temperature of about 1800 degrees Celsius.

18. The rotary motion machine of claim 15, wherein the first and second plurality of apertures are geometrically congruent.

19. A radially expandable piston for use in a rotary motion machine comprising a spiral of thin, flexible material coiled up about a central axis, the spiral including a first end and a second end positionable adjacent a first core plate and a second core plate, respectively, of the rotary motion machine, the first end and the second end of the spiral including in-folded portions that create a seal against the first core plate and the second core plate.

20. The radially expandable piston of claim 19, wherein the spiral is configured to allow a fluid in between spiral layers.

21. The radially expandable piston of claim 20, wherein projections are used to form portals for allowing fluid in between spiral layers.

22. The radially expandable piston of claim 19, further comprising a sealing member attachable to the spiral at an inner end for creating a seal against the spiral.

23. The radially expandable piston of claim 19, further comprising a folded portion at an inner end of the piston to prevent fluid from reaching an inner chamber defined by the spiral.

24. The radially expandable piston of claim 19, wherein the spiral includes a foil of amorphous material having a strip of a crystalline material for causing the spiral to expand after contraction.

25. A rotary motion machine, comprising:
a) at least one radially expandable piston defining an inner chamber that varies upon radial expansion and contraction of the piston, the piston including a spiral of thin, flexible material having a first end and a second end;
b) a core defining, at least in part, a cylinder in which the piston is positioned; and
c) a first core plate and a second core plate, wherein the first end and the second end of the spiral are positionable adjacent the first core plate and the second core plate, respectively, the first end and the second end including in-folded portions that create a seal against the first core plate and the second core plate.

26. The rotary motion machine of claim 25, further comprising a sealing member attachable to an inner end of the piston for creating a seal against the spiral.

27. The rotary motion machine of claim 25, wherein the spiral is configured to prevent a relatively incompressible fluid disposed outside the inner chamber from reaching therein.

28. The rotary motion machine of claim 25, wherein the first core plate and the second core plate include Al₂O₃N₂.

29. A rotary motion machine, comprising:
a) at least one radially expandable piston defining an inner chamber having a volume that varies upon radial expansion and contraction of the piston;
b) a core defining, at least in part, a cylinder in which the piston is positionable, the core having a plurality of apertures through which fluid flows to cool the machine; and
c) a rotor rotationally movable relative to the core and being rotated by a relatively incompressible fluid driven by expansion of the piston.

30. The rotary motion machine of claim 29, wherein the piston, core, and rotor are encased within a housing, the housing forming at least part of fluid channels that cooperate with the plurality of apertures in the core to provide fluid flow through the machine for cooling thereof.

31. The rotary motion machine of claim 30, wherein the housing defines at least part of an anechoic chamber for dampening engine noise.

32. The rotary motion machine of claim 29, further comprising a second core having at least one associated piston stacked on top of the core.

33. A radially expandable piston for use in a rotary motion machine comprising a spiral of thin, flexible material coiled about a central axis, the spiral being formed from a material having a melting temperature of about 3,200 degrees Celsius.

34. The piston of claim 33, wherein the piston has a thickness of about 25 micrometers.

35. The piston of claim 33, wherein the piston includes an amorphous, non-crystalline structure.

36. The piston of claim 33, wherein the piston is formed from a heat-reflective material.

37. The piston of claim 33, further comprising a strip of material attachable to the spiral for causing the spiral to expand after being contracted.

38. A radially expandable piston for use in a rotary motion machine comprising a spiral of thin, flexible material coiled about a central axis, the spiral being formed from a heat-reflective material.

39. A spiral of thin, flexible material coilable about a longitudinal axis for use in a rotary motion machine, the spiral including a first end configured to allow fluid in between coils.

40. The spiral of claim 39, wherein the spiral includes a second end that includes a sealing member for creating a seal against the spiral to prevent fluid from reaching an inner chamber defined by the spiral.

41. A rotary motion machine, comprising:
a) at least one radially expandable piston defining an inner chamber having a volume that varies upon radial expansion and contraction of the piston;
b) a first core plate and a second core plate bounding the piston on first and second ends thereof; and
c) at least one intake valve and at least one outlet valve mountable on the first core plate or the second core plate for communicating with the inner chamber of the piston, the intake valve and the outlet valve being substantially flush with that surface of the first core plate or the second core plate that bounds the piston.

42. The rotary motion machine of claim 41, wherein the intake valve and the outlet valve are mounted on the first core plate and the second core plate, respectively.

43. The rotary motion machine of claim 41, wherein the intake valve allows pre-compressed fluid into the chamber.

44. The rotary motion machine of claim 41, wherein the outlet valve allows exhaust produced from fuel combustion within the chamber to leave the chamber.

45. The rotary motion machine of claim 41, wherein the intake and outlet valves are shaped to maximize the amount of area above/below the inner chamber.

46. A rotary motion machine, comprising:
a) at least one radially expandable piston defining an inner chamber having a volume that varies upon radial expansion and contraction of the piston;
b) a first core plate and a second core plate bounding the piston on each end;
c) at least one intake valve and at least one outlet valve mountable on the first core plate or the second core plate; and
d) the second core plate defining at least part of an anechoic chamber adjacent at least the outlet valve for minimizing noise associated with fuel combustion within the piston.

47. The rotary motion machine of claim 46, wherein a housing forms at least part of the anechoic chamber.

48. A method for operating a rotary motion machine, comprising:
a) atomizing and injecting a liquid fuel into and along a length of a chamber defined by a radially expandable piston, the fuel combustion creating exhaust and causing the piston to radially expand;
b) replacing substantially all of the exhaust with pre-compressed fluid as the piston is caused to contract; and
c) repeating steps (a) and (b).

49. The method of claim 48, wherein the step of replacing substantially all of the exhaust with pre-compressed fluid is carried out at least while the piston is caused to contract.

50. The method of claim 48, wherein the piston is caused to contract by a relatively incompressible fluid propelled by a second radially expandable piston expanding due to fuel combustion therein.

51. The method of claim 50, further comprising rotating a rotor with the relatively incompressible fluid.

52. The method of claim 51, further comprising generating electricity by motion of at least one magnet associated with the rotor relative to a cooperatively arranged coil.

53. The method of claim 48, wherein at least one fuel injector that selectively injects liquid fuel into the chamber, a fluid intake valve that allows pre-compressed fluid into the chamber, and at least one outlet valve that selectively allows the exhaust to exit the chamber are closed during the fuel combustion.

54. The method of claim 53, further comprising opening the fluid intake valve and the outlet valve about when the piston has expanded to about its maximum dimension to allow the exhaust to leave the chamber as the piston is caused to contract.

55. The method of claim 54, further comprising closing the outlet valve about when substantially all of the exhaust has been replaced by the compressed fluid.

56. The method of claim 55, wherein substantially all of the exhaust has been replaced by the pre-compressed fluid about when the piston has contracted to about one-half its maximum diameter.

57. The method of claim 56, further comprising closing the fluid intake valve and the outlet valve about when the piston is contracted to about one-half its maximum diameter, the continued contraction of the piston further compressing the pre-compressed fluid.

58. The method of claim 56, wherein the fluid injector injects fuel into the chamber about when the piston is contracted to its minimum diameter to atomize and inject a liquid fuel into and along a length of the chamber.

59. A rotary motion machine, comprising:
a) at least one radially expandable piston defining an inner chamber having a volume that varies upon radial expansion and contraction of the piston, the piston being formed from a heat-reflective material to contain heat produced by fuel combustion within the chamber;
b) a core defining, at least in part, a cylinder in which the piston is positionable; and
c) a rotor rotationally movable relative to the core and being rotated by a relatively incompressible fluid driven by expansion of the piston.

60. The rotary motion machine of claim 59, further comprising at least one magnet associated with the rotor for generating electricity in a cooperatively arranged coil by motion of the magnet relative to coil.

61. A rotary motion machine, comprising:
a) at least one radially expandable piston defining an inner chamber having a volume that varies upon radial expansion and contraction of the piston;
b) a core defining, at least in part, a cylinder in which the piston is positionable, the core including a plurality of apertures for cooling the core for increasing the thermal efficiency of the machine thereby increasing torque; and
c) a rotor rotationally movable relative to the core and being rotated by a relatively incompressible fluid driven by expansion of the piston.

62. The rotary motion machine of claim 61, further comprising a fluid circulated through the plurality of apertures for cooling the core.

63. A rotary motion machine, comprising:
a) at least one radially expandable piston defining an inner chamber having a volume that varies upon radial expansion and contraction of the piston;
b) a core defining, at least in part, a cylinder in which the piston is positionable; and
c) a rotor rotationally movable relative to the core and being rotated by a relatively incompressible fluid driven by expansion of the piston;
the piston providing a maximum torque for rotating the rotor at about the initial combustion of fuel within the chamber.

64. A rotary motion pump, comprising a rotor driven about a central axis, the rotor having bearing surfaces that force a relatively incompressible fluid to cause at least one radially expandable piston to expand and contract about a longitudinal axis thereof, the motion of the expansion and contraction of the piston pumping a fluid along the longitudinal axis of the piston, the pump further including a one-way valve on each end of the piston to control the direction that the fluid is pumped.

65. The rotary motion pump of claim 64, wherein the rotor is driven by a belt.

66. The rotary motion pump of claim 64, wherein the pump is used in a medical device.

67. The rotary motion pump of claim 66, wherein the device includes an artificial heart to pump blood.
